(19) United States
(12) Patent Application Publication
(10) Pub. No.: US 2026/0243365 A1
(43) Pub. Date: Aug. 20, 2026

(54) SHAFT ASSEMBLY AND ELECTRIC VALVE

(71) Applicant: ZHEJIANG SANHUA AUTOMOTIVE COMPONENTS CO., LTD., Hangzhou, Zhejiang (CN)

(72) Inventors: Ren WANG, Hangzhou, Zhejiang (CN); Lixin WANG, Hangzhou, Zhejiang (CN)

(73) Assignee: ZHEJIANG SANHUA AUTOMOTIVE COMPONENTS CO., LTD., Hangzhou, Zhejiang (CN)

(21) Appl. No.: 18/995,285

(22) PCT Filed: Jul. 25, 2023
(86) PCT No.: PCT/CN2023/109058

§ 371 Date: Jan. 16, 2025

(30) Foreign Application Priority Data
Jul. 26, 2022 (CN) 202210881670.3

(51) Int. Cl. F16K 31/04; F16C 19/10; F16K 27/02

(52) U.S. Cl. CPC F16K 31/047; F16C 19/10; F16K 27/0254

(57) ABSTRACT

A shaft assembly and an electric valve are provided. The shaft assembly includes a compound motion assembly, a shaft rod assembly and a bearing assembly. The shaft rod assembly includes a shaft rod and a shaft sleeve, the shaft sleeve being connected to the shaft rod, and the shaft rod including a bottom wall portion. Part of the compound motion assembly is located between the shaft sleeve and the bottom wall portion in an axial direction of the shaft assembly; the bearing assembly is arranged between the shaft sleeve and the compound motion assembly in the axial direction of the shaft assembly, and the bearing assembly can abut against the shaft sleeve and the compound motion assembly; and/or the bearing assembly is arranged between the bottom wall portion and the compound motion assembly in the axial direction of the shaft assembly.

The present disclosure claims the priority to Chinese Patent Application No. 202210881670.3, titled “SHAFT ASSEMBLY AND ELECTRIC VALVE”, filed with the China National Intellectual Property Administration on Jul. 26, 2022, the entire disclosure of which is incorporated herein by reference.

### FIELD

The present disclosure relates to the technical field of fluid control, and in particular to a shaft assembly and an electric valve.

### BACKGROUND

Generally, a mechanical component, for example, an electric valve and the like, includes a shaft assembly, and the shaft assembly includes a compound motion rod and a moving rod. A rotational motion of the compound motion rod can be converted into a linear motion through a nut assembly, so that the compound motion rod can push the moving rod to move linearly. During the rotation of the compound motion rod, the rotational motion of the compound motion rod may be transmitted to the moving rod, which may easily cause wear of the compound motion rod and/or the moving rod.

### SUMMARY

An object of the present disclosure is to provide a shaft assembly and an electric valve, which can reduce wear of a compound motion assembly and/or a shaft rod assembly.

In an aspect, a shaft assembly is provided according to an embodiment of the present disclosure, including a compound motion assembly, a shaft rod assembly and a bearing assembly,
the compound motion assembly is rotatable around an axis of the compound motion assembly and is movable, and the shaft rod assembly is movable when being pushed by the compound motion assembly;
the shaft rod assembly includes a shaft rod and a bushing that are connected to each other, and the shaft rod includes a bottom wall portion;
a part of the compound motion assembly is located between the bushing and the bottom wall portion in an axial direction of the shaft assembly, where
the bearing assembly is provided between the bushing and the compound motion assembly along the axial direction of the shaft assembly, and abuts against the bushing and the compound motion assembly, and/or, the bearing assembly is provided between the bottom wall portion and the compound motion assembly in the axial direction of the shaft assembly, and can abut against the bottom wall portion and the compound motion assembly; and
the bearing assembly includes multiple rotating members that are arranged in a circumferential direction of the compound motion assembly, and the multiple rotating members are rotatable under an action of the compound motion assembly.

In another aspect, an electric valve with a valve port and a valve chamber is provided according to an embodiment of the present disclosure, including a housing, a cover assembly and the shaft assembly described above, where
the cover assembly and the housing are sealedly connected, and the shaft rod of the shaft assembly is movable towards or away from the valve port; and
the housing and the cover assembly form at least a part of a wall portion of the valve chamber, and a part of the shaft rod extends through the cover assembly and is located in the valve chamber.

According to the shaft assembly provided in the embodiment of the present disclosure, the shaft assembly includes the compound motion assembly, the shaft rod assembly and the bearing assembly. The compound motion assembly is rotatable and can drive the shaft rod assembly to move. In order to reduce the friction between the compound motion assembly and the shaft rod assembly, in the embodiment of the present disclosure, the bearing assembly is provided between the bushing and the compound motion assembly in the axial direction of the shaft assembly and can abut against the bushing and the compound motion assembly; and/or, the bearing assembly is provided between the bottom wall portion and the compound motion assembly in the axial direction of the shaft assembly, and can abut against the bottom wall portion and the compound motion assembly. In this way, the bushing and/or the shaft rod is not in direct contact with the compound motion assembly, and motions are transmitted between the compound motion assembly and the bushing and/or the shaft rod through the bearing assembly. Further, the bearing assembly includes the multiple rotating members that are arranged in the circumferential direction of the compound motion assembly, and the multiple rotating members are rotatable under the action of the compound motion assembly. Compared with a sliding friction generated by direct contact between the compound motion assembly and the bearing assembly, a rotational friction generated by the rotational motion of the rotating members is smaller than the sliding friction generated by the direct contact between the compound motion assembly and the bearing assembly, thereby reducing the friction force applied on the compound motion assembly and/or the shaft rod assembly, and thus reducing the wear of the compound motion assembly and/or the shaft rod assembly.

The electric valve according to the embodiment of the present disclosure includes the housing, the cover assembly and the above shaft assembly. The shaft rod of the shaft assembly moves towards or away from the valve port, thereby achieving at least one of communication, blocking and flow rate regulation of the valve port. Furthermore, the shaft assembly of the electric valve is provided with the bearing assembly, the multiple rotating members of the bearing assembly are arranged in the circumferential direction of the compound motion assembly, and are rotatable under the action of the compound motion assembly. The wear of the compound motion assembly and/or the shaft rod assembly can be reduced by the rotational motion of the rotating members.

### BRIEF DESCRIPTION OF THE DRAWINGS

FIG. 1 is a schematic perspective view of an electric valve according to an embodiment of the present disclosure;

FIG. 2 is a schematic structural cross sectional view of the electric valve in FIG. 1 at one position;

FIG. 3 is a schematic structural cross sectional view of the electric valve in FIG. 1 at another position;

FIG. 4 is a schematic structural view of a shaft assembly according to an embodiment of the present disclosure;

FIG. 5 is a schematic structural cross sectional view of the shaft assembly in FIG. 4 at one position;

FIG. 6 is a schematic enlarged structural view of the shaft assembly in FIG. 5 at a portion Q;

FIG. 7 is a schematic broken structural view of a first rod in FIG. 5;

FIG. 8 is a schematic structural view of a bearing assembly in FIG. 5;

FIG. 9 is a schematic structural cross sectional view of the bearing assembly in FIG. 8 at one position;

FIG. 10 is a schematic partial structural view of a shaft rod assembly in FIG. 5;

FIG. 11 is a schematic partial structural cross sectional view of the shaft rod assembly in FIG. 10;

FIG. 12 is a schematic structural view of a part of the electric valve in FIG. 1;

FIG. 13 is a schematic structural cross sectional view of the part of the electric valve in FIG. 12;

FIG. 14 is a schematic perspective view of a cover assembly in FIG. 2;

FIG. 15 is a schematic structural cross sectional view of the cover assembly in FIG. 14; and

FIG. 16 is a schematic structural view of another part of the electric valve in FIG. 1.

### DETAILED DESCRIPTION OF THE EMBODIMENTS

The features and exemplary embodiments of various aspects of the present disclosure will be described hereinafter. The present disclosure will be further described as follows in conjunction with the accompany drawings and the specific embodiments, so that purposes, technical solutions and advantages of the present disclosure can be more clear and understandable. Herein, relational terms such as “first” and “second” are only used to distinguish one component from another component having the same name, and do not necessarily require or imply any such actual relationship or order among these components.

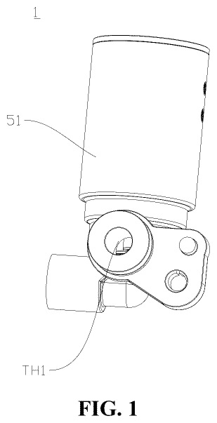

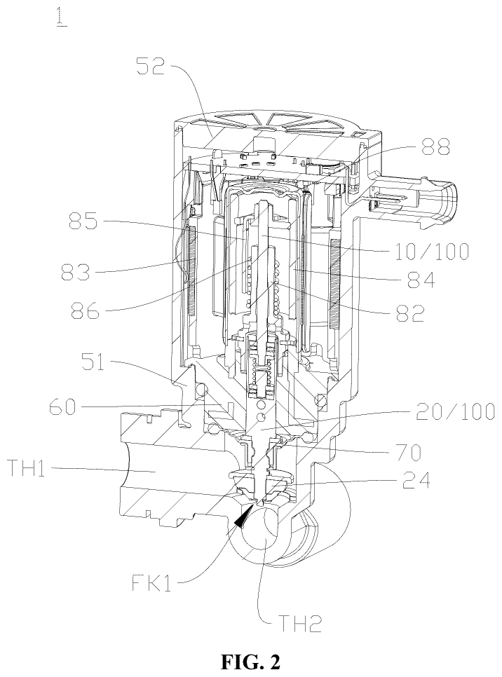

As shown in FIG. 1 to FIG. 3, an electric valve 1 is provided according to an embodiment of the present disclosure. The electric valve 1 may be applied to a fluid medium pipeline system to communicate, block or regulate a fluid flow rate. Optionally, the electric valve 1 may be applied to an air conditioning system, an engine cooling system, a battery cooling system or a fuel supply system.

The electric valve 1 has a valve port FK1, a valve chamber FK2, a first passage TH1 and a second passage TH2, and the first passage TH1 and the second passage TH2 can be in communication with each other through the valve port FK1. The electric valve 1 includes a housing 51, a cover assembly 60, a shaft assembly 100 and a piston 24. The cover assembly 60 and the housing 51 are sealedly connected. For example, a seal ring is tightly sandwiched between the cover assembly 60 and the housing 51 to realize the sealing between the cover assembly 60 and the housing 51. The cover assembly 60 and the housing 51 form at least a part of a wall portion of the valve chamber FK2. The shaft assembly 100 includes a shaft rod 20, and the shaft rod 20 includes a main body portion 25. The main body portion 25 is located on one side of the shaft rod 20, and the piston 24 is connected to the main body portion 25 of the shaft rod 20. A part of the shaft rod 20 and the piston 24 are located in the valve chamber FK2, and the shaft rod 20 can drive the piston 24 to move towards or away from the valve port FK1. A part of the shaft rod 20 extends through the cover assembly 60 and is located in the valve chamber FK2, so that the cover assembly 60 can guide and limit the shaft rod 20. The shaft rod 20 can drive the piston 24 to move towards or away from the valve port FK1, so that the communication between the first passage TH1 and the second passage TH2 can be on/off. In this way, the electric valve according to the embodiment of the present disclosure can communicate, block, or regulate the fluid flow rate.

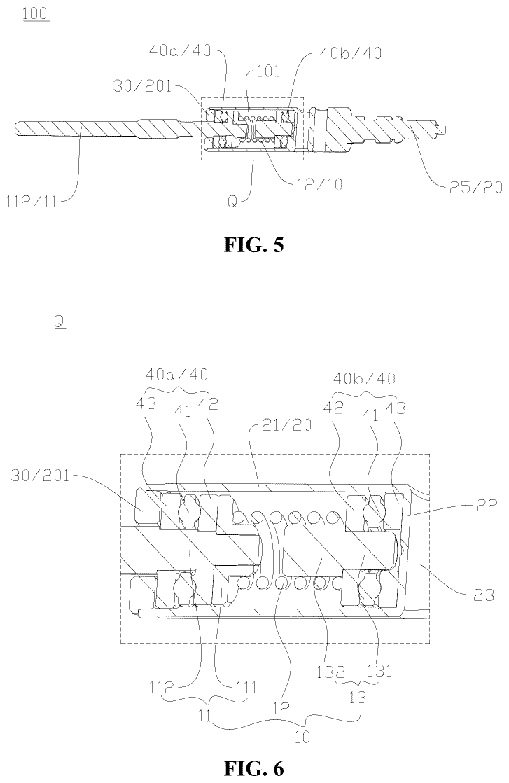

In order to achieve a stable linear movement of the shaft rod 20 of the shaft assembly 100 and to improve the service life of the shaft assembly 100, as shown in FIG. 4 and FIG. 6, a shaft assembly 100 is further provided according to an embodiment of the present disclosure. The shaft assembly 100 may be applied to the electric valve 1 shown in FIG. 1 to FIG. 3, thereby improving the service life of the electric valve 1.

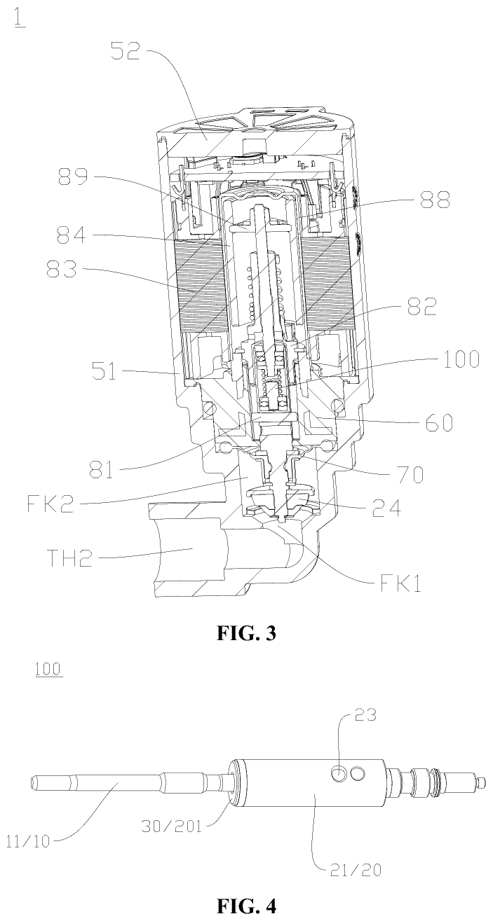

As shown in FIG. 3 to FIG. 6, the shaft assembly 100 has a first accommodation chamber 101. The shaft assembly 100 includes a compound motion assembly 10, a shaft rod assembly 201 and a bearing assembly 40. A part of the compound motion assembly 10 and the bearing assembly 40 are located in the first accommodation chamber 101. The compound motion assembly 10 is rotatable around an axis of the compound motion assembly 10 and is movable. In practice, the compound motion assembly 10 can move in a direction parallel to or coincident with its own axis, or move in a direction that intersects with its axis by an angle. For example, as shown in FIG. 1 to FIG. 3, the electric valve 1 may further include a nut assembly 82, which can convert a rotational motion of the compound motion assembly 10 into a translational motion of the compound motion assembly 10. The shaft rod assembly 201 is movable when being pushed by the compound motion assembly 10. For example, the shaft rod assembly 201 may move along its own axis when being pushed by the compound motion assembly 10, and the axis of the compound motion assembly 10 is parallel to or coincides with the axis of the shaft rod assembly 201.

The shaft rod assembly 201 includes the shaft rod 20 and a bushing 30, and the bushing 30 is connected to an end of the shaft rod 20. For example, as shown in FIG. 6, a part of the bushing 30 may be inserted into the shaft rod 20, and may be in direct contact with the shaft rod 20 and fixed thereto by laser welding. In some other embodiments, the bushing 30 may be indirectly connected to the shaft rod 20 through other components, so that the bushing 30 can move with the shaft rod 20 synchronously. The shaft rod 20 includes a side wall portion 21 and a bottom wall portion 22. The bushing 30, the side wall portion 21 and the bottom wall portion 22 form at least a part of a wall portion of the first accommodation chamber 101. At least a part of the bushing 30 and at least a part of the bottom wall portion 22 are arranged in an axial direction of the shaft assembly 100. At least a part of the side wall portion 21 is located between the bushing 30 and the bottom wall portion 22 in the axial direction of the shaft assembly 100, and a part of the compound motion assembly 10 is located between the bushing 30 and the bottom wall portion 22 and located in the accommodating cavity 101 in the axial direction of the shaft assembly 100.

When rotating, the compound motion assembly 10 can push the bushing 30 and the shaft rod 20 to move. If the compound motion assembly 10 is in contact with the bushing 30 or the shaft rod 20 directly or through other components, a sliding friction force between the compound motion assembly 10 and the bushing 30 or the shaft rod 20 due to the direct contact or the contact through other components is relatively huge, which may easily cause wear of the two components between which the friction force is generated.

To solve the above problem, the bearing assembly 40 according to the embodiment of the present disclosure is located in the first accommodation chamber 101. In an axial direction of the compound motion assembly 10, at least one bearing assembly 40 is provided between the compound motion assembly 10 and at least one of the bushing 30 and the bottom wall portion 22. In this case, the at least one bearing assembly 40 may be provided between the bushing 30 and the compound motion assembly 10 in the axial direction of the shaft assembly 100 and abut against the bushing 30 and the compound motion assembly 10, and/or, the at least one bearing assembly 40 may be provided between the bottom wall portion 22 and the compound motion assembly 10 in the axial direction of the shaft assembly 100, and abut against the bottom wall portion 22 and the compound motion assembly 10. In this way, the bushing 30 and/or the shaft rod 20 are not in directly contact with the compound motion assembly 10, and motions between the compound motion assembly 10 and the bushing 30 and/or the shaft rod 20 are transmitted through the bearing assembly 40.

Further, as shown in FIG. 6 to FIG. 9, the at least one bearing assembly 40 includes a bracket 41, and the bracket 41 includes a bracket 411 and multiple rotating members 412. The bracket 411 is provided on the compound motion assembly 10, and the multiple rotating members 412 are arranged along a circumferential direction of the compound motion assembly 10. The multiple rotating members 412 are all connected to the bracket 411 in a limited manner, and are rotatable under an action of the compound motion assembly 10. With the above arrangement, when rotating, the compound motion assembly 10 can drive the rotating members 412 between the compound motion assembly 10 and the shaft rod assembly 201 to rotate. A rotational friction generated by the rotational motion of the rotating members 412 is smaller than a sliding friction generated by the direct contact between the compound motion assembly 10 and the bearing assembly 40, thereby reducing a friction force applied on the compound motion assembly 10 and/or the shaft rod assembly 201 and thus the wear of the compound motion assembly 10 and/or the shaft rod assembly 201. The rotating members 412 herein may be one or a combination of bearing balls and needle rollers.

Referring to FIG. 4 to FIG. 9, in some embodiments, the bearing assembly 40 further includes a first bearing ring 42 and a second bearing ring 43. The bracket 41 is located between the first bearing ring 42 and the second bearing ring 43 in an axial direction of the bearing assembly 40, and the compound motion assembly 10 extends through both the first bearing ring 42 and the second bearing ring 43. In a radial direction of the bearing assembly 40, one of the first bearing ring 42 and the second bearing ring 43 is in interference fit with the compound motion assembly 10, and a gap is provided between the other one of the first bearing ring 42 and the second bearing ring 43 and the compound motion assembly 10. As an example for description herein, the first bearing ring 42 is in interference fit with the compound motion assembly 10, and a gap is provided between the second bearing ring 43 and the compound motion assembly 10 in the radial direction. The axial direction of the bearing assembly 40, the axial direction of the compound motion assembly 10 and an axial direction of the shaft rod assembly 201 are parallel to each other or coincide with each other. With the above arrangement, the bearing assembly 40 can bear an axial load. As such, when rotating, the compound motion assembly 10 drives the first bearing ring 42 to rotate, which further drives the rotating members 412 in the bracket 41 to rotate. At this time, the second bearing ring 43 does not rotate or rotate rarely, thereby reducing the friction torque among the compound motion assembly 10, the bearing assembly 40 and the shaft rod assembly 201, and thus reducing the wear of the compound motion assembly 10 and/or the shaft rod assembly 201.

In order to reduce the wear between the compound motion assembly 10 and the shaft rod 20 and between the compound motion assembly 10 and the bushing 30, in some embodiments, the bearing assembly 40 includes a first bearing assembly 40a and a second bearing assembly 40b. The first bearing assembly 40a is located between the bushing 30 and the compound motion assembly 10, and the second bearing assembly 40b is located between the compound motion assembly 10 and the bottom wall portion 22. The first bearing assembly 40a is a thrust ball bearing or a needle roller thrust bearing, and/or, the second bearing assembly 40b is a thrust ball bearing or a needle roller thrust bearing. In practice, the first bearing assembly 40a and the second bearing assembly 40b are the same, and may both be ball thrust bearings, so as to reduce the structural size of the shaft assembly 100. It may be understood that, in a case that the first bearing assembly 40a and/or the second bearing assembly 40b are needle roller thrust bearing, the needle roller thrust bearing may include the bracket 41 and needle rollers arranged on the bracket 41, and the needle roller thrust bearing may be not provided with the first bearing ring 42 and the second bearing ring 43. The needle rollers serves as the rotating members 412, which can not only rotate but also bear the axial load. Alternatively, in other embodiments, the needle roller thrust bearing may be provided with at least one of the first bearing ring 42 and the second bearing ring 43, which is not limited herein.

Further, as shown in FIG. 5 and FIG. 6, in some embodiments, the compound motion assembly 10 includes a first rod assembly 11, an elastic member 12 and a second rod 13. The first rod assembly 11 and the second rod 13 are formed separately, which are arranged in the axial direction of the compound motion assembly 10. A part of the elastic member 12 is provided on the first rod assembly 11, and another part of the elastic member 12 is provided on the second rod 13. When the first rod assembly 11 is rotating, a rotational force can be transmitted from the first rod assembly 11 to the second rod 13 via the elastic member 12, to drive the second rod 13 to rotate. With the above arrangement, when rotating, the compound motion assembly 10 can well drive the shaft rod assembly 201 to move towards or away from the valve port. A part of the first rod assembly 11 extends through a through hole of the bushing 30 and is located in the first accommodation chamber 101, and the second rod 13 is located closer to the bottom wall portion 22 than the first rod assembly 11 is. The first bearing assembly 40a is provided on the first rod assembly 11, and the second bearing assembly 40b is provided on the second rod 13. The elastic member 12 is located between the first bearing assembly 40a and the second bearing assembly 40b in the axial direction of the compound motion assembly 10. In practice, the elastic member 12 may be a spring. The first bearing assembly 40a is provided on an outer circumferential side of a part of the first rod assembly 11, and the second bearing assembly 40b is provided on an outer circumferential side of a part of the second rod 13. Each of the first bearing assembly 40a and the second bearing assembly 40b includes the bracket 41, the first bearing ring 42 and the second bearing ring 43. As shown in FIG. 6, the compound motion assembly 10 can drive the shaft rod assembly 201 to move in a left-right direction in FIG. 6. With the above arrangement, the wear between the compound motion assembly 10 and the bottom wall portion 22 can be reduced when the compound motion assembly 10 moves rightwards, and the wear between the compound motion assembly 10 and the bushing 30 can be reduced when the compound motion assembly 10 moves to the leftwards.

Further referring to FIG. 6, in some embodiments, the first rod assembly 11 includes a flange 111 and a first rod 112 that are connected to each other. Optionally, the flange 111 and the first rod 112 may be an integral structure; or, the flange 111 and the first rod 112 may be formed separately and be in interference fit with each other or be fixed to each other by welding. The first bearing assembly 40a is located between the flange 111 and the bushing 30 in the axial direction of the compound motion assembly 10. The second rod 13 includes a first shaft portion 131 and a second shaft portion 132. At least a part of an orthographic projection of the first shaft portion 131 is positioned within an orthographic projection of the second shaft portion 132 in an axial direction of the second rod 13. In this case, a diameter of the first shaft portion 131 is smaller than a diameter of the second shaft portion 132. The second bearing assembly 40b is provided on the first shaft portion 131. In the axial direction of the second rod 13, the second bearing assembly 40b is located between the second shaft portion 132 and the bottom wall portion 22, and the elastic member 12 is located between the flange 111 and the second bearing assembly 40b. A gap is provided between the first shaft portion 131 and the bottom wall portion 22 in the axial direction of the compound motion assembly 10. With the above arrangement, the first bearing assembly 40 and the second bearing assembly 40b can be axially limited.

In order to locate the first bearing assembly 40a and the second bearing assembly 40b at appropriate positions to reduce the wear between the compound motion assembly 10 and the shaft rod assembly 201, in some embodiments, for the first bearing assembly 40a, the second bearing ring 43 is located between the first bearing ring 42 and the bushing 30 in an axial direction of the first bearing assembly 40a. The first bearing ring 42 is provided on an outer circumferential side of the first rod 112 and is in interference fit with the first rod 112, and the first bearing ring 42 can abut against the flange 111. A gap is provided between the second bearing ring 43 and the first rod 112 in a radial direction of the first rod 112, and the second bearing ring 43 can abut against the bushing 30. In this case, the first bearing ring 42 is a tight ring, and the second bearing ring 43 is a loose ring. In FIG. 6, when rotating and moving leftwards, the compound motion assembly 10 drives the first bearing ring 42 to rotate, which further drives the rotating members 412 to rotate. When the second bearing ring 43 abuts against the bushing 30, the second bearing ring 43 can push the bushing 30 and the shaft rod 20 to move leftwards. At this time, the second bearing ring 43 does not rotate or rotates rarely, and nearly no sliding friction force is generated between the second bearing ring 43 and the bushing 30. In this way, the friction torque between the second bearing ring 43 and the bushing 30 can be reduced, thereby reducing the wear of the bushing 30.

And/or, for the second bearing assembly 40b, the second bearing ring 43 is located between the first bearing ring 42 and the bottom wall portion 22. The first bearing ring 42 is in interference fit with the first shaft portion 131 and can abut against the second shaft portion 132. A gap is provided between the second bearing ring 43 and the first shaft portion 131 in the radial direction of the second rod 13, and an outer wall surface of the second bearing ring 43 is in interference fit with an inner surface of the side wall portion 21, so that the second bearing ring 43 is axially limited. The second bearing ring 43 can abut against the bottom wall portion 22. In this case, the first bearing ring 42 is a tight ring. When the second bearing ring 43 abuts against the bottom wall portion 22, the second bearing ring 43 can push the shaft rod 20 to move rightwards. In this case, the second bearing ring 43 is a loose ring. In FIG. 6, when rotating and moving rightwards, the compound motion assembly 10 drives the first bearing ring 42 to rotate, which further drives the rotating members 412 to rotate. At this time, the second bearing ring 43 does not rotate or rotates rarely, and nearly no sliding friction force is generated between the second bearing ring 43 and the bottom wall portion 22. In this way, the friction torque between the second bearing ring 43 and the bottom wall portion 22 can be reduced, so as to reduce the wear of the bottom wall portion 22, thereby reducing the wear of the shaft rod 20.

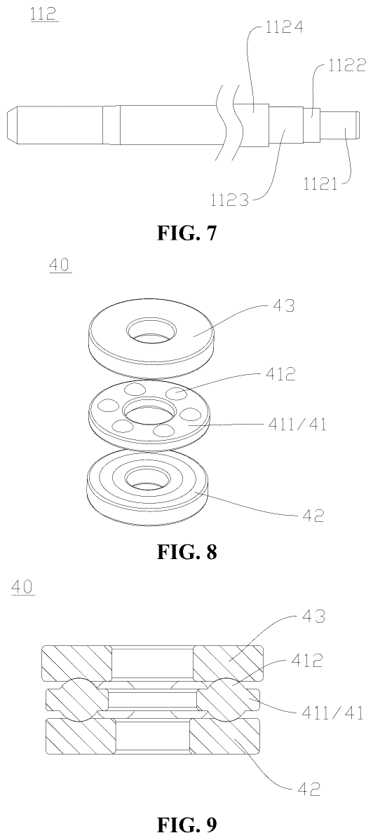

As shown in FIG. 6 and FIG. 7, in order to better limit the first bearing ring 42 and the second bearing ring 43 of the first bearing assembly 40a, in some embodiments, the first rod 112 includes a third shaft portion 1121, a fourth shaft portion 1122, a fifth shaft portion 1123 and a sixth shaft portion 1124 that are arranged in the listed sequence along an axial direction of the first rod 112. In the axial direction of the first rod 112, at least a part of an orthographic projection of the third shaft portion 1121 is positioned within an orthographic projection of the fourth shaft portion 1122, at least a part of the orthographic projection of the fourth shaft portion 1122 is positioned within an orthographic projection of the fifth shaft portion 1123, and at least a part of the orthographic projection of the fifth shaft portion 1123 is positioned within an orthographic projection of the sixth shaft portion 1124. In this case, a diameter of the third shaft portion 1121 is smaller than a diameter of the fourth shaft portion 1122, the diameter of the fourth shaft portion 1122 is smaller than a diameter of the fifth shaft portion 1123, and the diameter of the fifth shaft portion 1123 is smaller than a diameter of the sixth shaft portion 1124. In this case, a first shaft shoulder is formed between the third shaft portion 1121 and the fourth shaft portion 1122, a second shaft shoulder is formed between the fourth shaft portion 1122 and the fifth shaft portion 1123, and a third shaft shoulder is formed between the fifth shaft portion 1123 and the sixth shaft portion 1124. By the provision of the shaft shoulder structures, the bracket 41, the first bearing ring 41 and the second bearing ring 43 can be limited.

Based on this, the flange 111 is provided on an outer surface side of the third shaft portion 1121 and abuts against the first shaft shoulder. For the first bearing assembly 40a, the first bearing ring 42 is provided on an outer circumferential side of the fourth shaft portion 1122 and is in interference fit with the fourth shaft portion 1122, and the first bearing ring 42 abuts against the second shaft shoulder. The bracket 41 and the second bearing ring 43 are both provided on an outer circumferential side of the fifth shaft portion 1123. In this case, the rotating members 412 are circumferentially arranged around the outer circumferential side of the fifth shaft portion 1123. The second bearing ring 43 abuts against the third shaft shoulder, and a gap is provided between the second bearing ring 43 and the fifth shaft portion 1123 in the radial direction of the first rod 112. The bushing 30 is provided on an outer circumferential side of the sixth shaft portion 1124. By provision of the first shaft shoulder, the flange 111 can be axially limited, which facilitates the assembling of the flange 111. By provision of the second shaft shoulder, the first bearing ring 42 of the first bearing assembly 40a can be axially limited, and the second bearing ring 43 is prevented from being pressed tightly, so that the second bearing ring 43 almost does not rotate. By provision of the third shaft shoulder, as shown in FIG. 6, the second bearing ring 43 can be axially limited when the compound motion assembly 10 moves rightwards, so as to prevent the second bearing ring 43, the bracket 41 and the first bearing ring 42 of the first bearing assembly 40a from being separated.

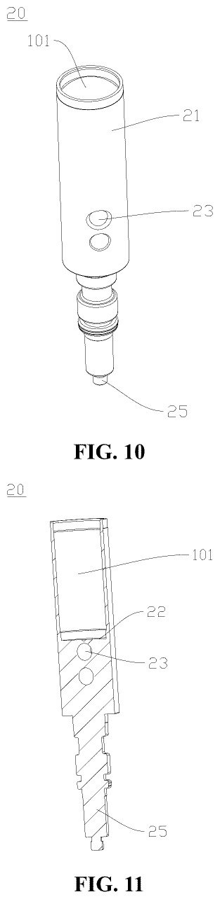

As shown in FIG. 10 and FIG. 11, in order to reduce the rotation of the shaft rod 20, in some embodiments, the shaft rod 20 is further provided with a through hole 23. A hole wall of the through hole 23 is located on a side of the bottom wall portion 22 away from the bushing 30 in the axial direction of the shaft rod 20. In this case, the through hole 23 is located between the bottom wall portion 22 and the main body portion 25. By provision of the through hole 23, an anti-rotation pin can be provided in the through hole 23 when the shaft assembly 100 is applied to the electric pump shown in FIG. 1 to FIG. 3 or other components. The anti-rotation pin is in cooperation with an anti-rotation groove of the electric pump or other components, and thus the rotation of the shaft assembly 20 can be well reduced or prevented.

Based on the above possible embodiments, the service life of the electric valve 1 can be improved and the driving force can be reduced when the shaft assembly 100 shown in FIG. 4 to FIG. 11 is applied to the electric valve 1. The structure of the electric valve 1 is further described hereinafter.

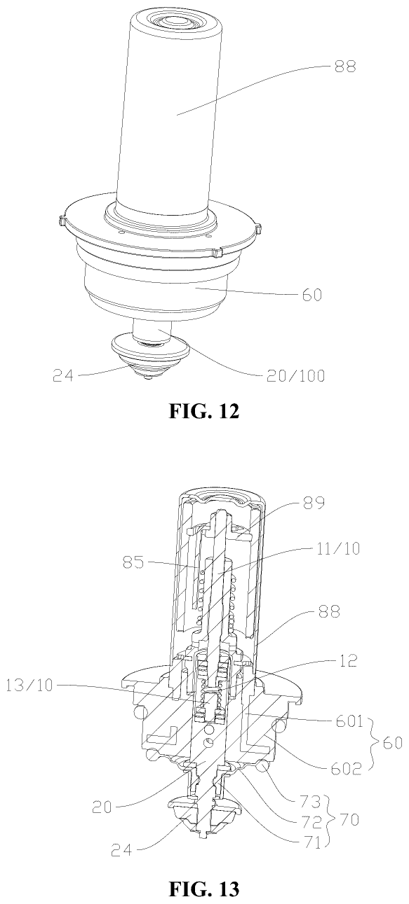

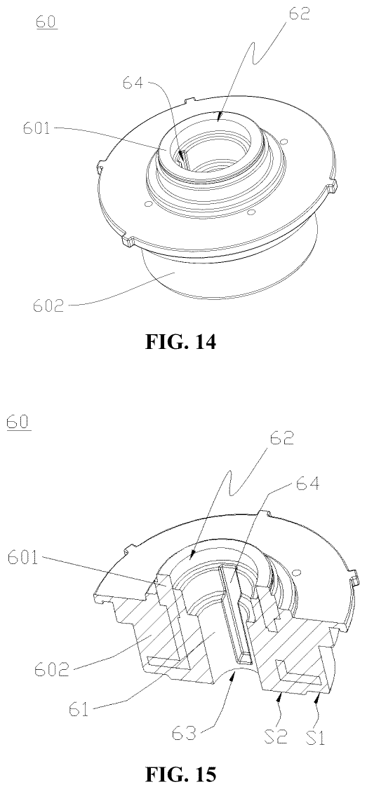

As shown in FIG. 1 to FIG. 3, and FIG. 12 to FIG. 15, in some embodiments, the electric valve 1 further includes an end cover 52, a stator assembly 83, a rotor assembly 84 and a connector 89. The end cover 52 and the housing 51 may be sealedly connected by welding. The cover assembly 60 is located in the housing 51, and the stator assembly 83 and the rotor assembly 84 are located in a space defined by the end cover 52 and the housing 51. The stator assembly 83 includes a coil. When the coil is powered to be operated, the rotor assembly 84 is in a magnetic field of the coil, so that the coil drives the rotor assembly 84 to rotate. The compound motion assembly 10 of the shaft assembly 100 is connected to the rotor assembly 84 through the connector 89, so that the rotor assembly 84 drives the compound motion assembly 10 to rotate. Optionally, the compound motion assembly 10 may be connected to the connector 89 by welding or be in interference fit with the connector 89. In order to prevent the coil of the stator assembly 83 from being damaged by a fluid, in some embodiments, the electric valve 1 further includes an isolation sleeve 88 that is provided on an outer circumferential side of a part of the rotor assembly 84. The isolation sleeve 88 may be sealedly connected to the cover assembly 60 by welding, so that a chamber where the stator assembly 83 is located and a chamber where the rotor assembly 84 is located are isolated from each other.

In order to convert the rotational motion of the compound motion assembly 10 into the linear motion, in some embodiments, the electric valve may further include a nut assembly 82. At least a part of the nut assembly 82 is located on a side of the cover assembly 60 away from the valve port FK1. A part of the nut assembly 82 is provided on the outer circumferential side of a part of the first rod 112 and is located inside an inner circumferential side of a part of the rotor assembly 84, and the nut assembly 82 is in a threaded connection to the first rod 112. In order to limit a position of the nut assembly 82, in some embodiments, a part of the nut assembly 82 is provided on an inner side of the cover assembly 60, and the nut assembly 82 may be connected to the cover assembly 60 by welding.

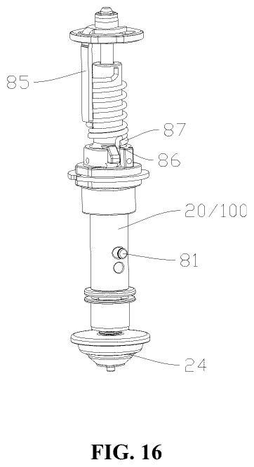

Further, as shown in FIG. 12 to FIG. 16, in order to limit a rotation position of the compound motion assembly 10, in some embodiments, the electric valve 1 further includes a stop rod 85, a spring guide rail 86 and a slide ring 87. A part of the spring guide rail 86 is provided on an outer circumferential side of a part of the nut assembly 82, and the spring guide rail 86 is located between the connector 89 and the cover assembly 60 in the axial direction of the compound motion assembly 10. An end of the spring guide rail 86 may be limitedly arranged with the nut assembly 82, so as to prevent the spring guide rail 86 from moving in the axial direction of the compound motion assembly 10. The slide ring 87 is spiral and is embedded in a gap of a coil of the spring guide rail 86. The stop rod 85 is connected to the connector 89 in a limited manner and extends towards the nut assembly 82. When rotating, the compound motion assembly 10 can move linearly through the nut assembly 82, and drives the slide ring 87 to spirally move around a central axis of the nut assembly 82 along the spiral rail of the spring guide rail 86. When the slide ring 87 abuts against the stop rod 85 or the nut assembly 83, the compound motion assembly 10 can be axially limited.

Further referring to FIG. 12 to FIG. 15, in some embodiments, the cover assembly 60 is provided with a second accommodation chamber 61, a mounting opening 62 and a limiting opening 63. The mounting opening 62 and the limiting opening 63 are respectively located on both axial sides of the cover assembly 60, and are in communication with each other through the second accommodation chamber 61. A part of the shaft rod 20 is interposed inside a portion where the limiting opening 63 is located, so that the cover assembly 60 limits the shaft rod 20 and guides an axial movement of the shaft rod 20. In order to prevent the shaft rod 20 from rotating, the shaft rod 20 of the shaft assembly 100 is provided with the through hole 23. The electric valve 1 further includes an anti-rotation pin 81 that is located in the second accommodation chamber 61. The anti-rotation pin 81 extends through the through hole 23 and is limitedly arranged with the cover assembly 60. A n inner diameter of at least a part of the mounting opening 62 is larger than or equal to a axial length of the anti-rotation pin 81, and an inner diameter of the limiting opening 63 is smaller than the axial length of the anti-rotation pin 81. With the above arrangement, during mounting the anti-rotation pin 81, the anti-rotation pin 81 can be mounted to the second accommodation chamber 61 from the mounting opening 62. Compared with a case that the anti-rotation pin 81 is mounted from the limiting opening 63, the diameter of the limiting opening 63 can be reduced. In order to prevent the anti-rotation pin 81 from rotating, the cover assembly 60 is provided with a limiting groove 64, which has a limiting surface that extends in the axial direction of the cover assembly 60 and is arranged along a circumferential direction of the cover assembly 60. Both axial ends of the anti-rotation pin 81 are located in the limiting groove 64, so that the limiting surface can limit the anti-rotation pin 81, thereby reducing or preventing the rotation of the anti-rotation pin 81.

The nut assembly 82 may be connected to the cover assembly 60 by welding. In order to facilitate welding, the cover assembly 60 includes a first cover portion 601 and a second cover portion 602. The first cover portion 601 and the second cover portion 602 may be made of different materials. For example, the first cover portion 601 is made of metal, and the second cover portion 602 is made of plastic. The first cover portion 601 may serve as an insert to be connected to the second cover portion 602 by injection molding, and a part of the first cover portion 601 protrudes outside the second cover portion 602 to facilitate of welding the first cover portion 601 with the nut assembly 82. For example, as shown in FIG. 3 and FIG. 13, the part of the first cover portion 601 protrudes from an axial end face of the second cover portion 602 in the axial direction of the shaft rod 20, which facilitates of welding the first cover portion 601 with the nut assembly 82.

Further, in order to reduce or prevent the fluid from flowing into the chamber where the rotor assembly 84 is located from the valve chamber FK2, as shown in FIG. 1 to FIG. 3, and FIG. 13, the electric valve 1 according to the embodiment of the present disclosure further includes a diaphragm seal 70 that is provided on an outer circumferential side of a part of the shaft rod 20. The diaphragm seal 70 includes a first part 71, a second part 72 and a third part 73 each of which is of an annular structure. The first part 71 is connected to the third part 73 through the second part 72. The first part 71 is provided on an outer surface side of a part of the shaft rod 20 and is sealedly connected to the shaft rod 20. The third part 73 is sandwiched between the housing 51 and the cover assembly 60, and the second part 72 can deform along with the movement of the shaft rod 20. With the above arrangement, the diaphragm seal 70 can achieve a good sealing performance.

The anti-rotation pin 81 is mounted from the mounting opening 62, and thus the limiting opening 63 has a smaller diameter. Further referring to FIG. 13 to FIG. 15, in some embodiments, the cover assembly 60 has a first surface S1 and a second surface S2. The second surface S2 is located on an inner side of the first surface S1 in a radial direction of the cover assembly 60, and the first surface S1 abuts against the third part 73. The second surface S2 is arranged closer to the second part 72 of the diaphragm seal 70 than the first surface S1 in the axial direction of the cover assembly 60. The limiting opening 63 is located on the second surface S2. Since the inner diameter of the limiting opening 63 is relatively small, an area of the second surface S2 is relatively large. Therefore, when the fluid in the electric valve 1 applies a pressure on the diaphragm seal 70, at least a part of the second part 72 is in tight contact with the second surface S2 due to the pressure and moves back and forth. Compared with a case that the limiting opening has a large diameter and a chamfer structure extending towards the second accommodation chamber needs to be provided as the anti-rotation pin 81 is mounted from the limiting opening 63, which may easily cause excessive stretching of the second part, according to the embodiment of the present disclosure, since the second surface S2 has a relatively large area and is arranged closer to the second part 72 of the diaphragm seal 70, the excessive stretching of the diaphragm seal 70 can be reduced or eliminated in the electric valve provided according to the embodiment of the present disclosure, thereby improving the service life of the diaphragm seal 70 and further improving the service life of the electric valve.

It may be appreciated that, the housing 51 according to the embodiment of the present disclosure may be one single structural component, such as a one-piece injection molded component, or may be a structure formed by multiple components arranged in a sealed manner. The shaft assembly 100 according to the embodiment of the present disclosure may be not only applied to the above electric valve 1, but also be applied to other components that include a compound motion assembly and a shaft rod assembly.

In summary, according to the shaft assembly 100 and the electric valve 1 provided in the embodiment of the present disclosure, the shaft assembly 100 includes the compound motion assembly 10, the shaft rod assembly 201 and the bearing assembly 40. The bushing 30 and the bottom wall portion 22 of the shaft rod assembly 201 together form a part of the wall portion of the first accommodation chamber 101, and the part of the compound motion assembly 10 and the bearing assembly 40 are located in the first accommodation chamber. In the embodiment of the present disclosure, the compound motion assembly 10 is rotatable and can push the shaft rod assembly 201 to move, and thus, in order to reduce the friction between the compound motion assembly 10 and the shaft rod assembly 201, at least one bearing assembly 40 is provided between the compound motion assembly 10 and at least one of the bushing 30 and the bottom wall portion 22. The multiple rotating members 412 of the bearing assembly 40 are arranged along the circumferential direction of the compound motion assembly 10 and connected to the bracket 411 in a limited manner, and the multiple rotating members 412 are rotatable, so that the rotating members 412 can rotate under the action of the compound motion assembly 10. Compared with the sliding friction generated by the direct contact between the compound motion assembly and the bearing assembly, in the present disclosure, the friction force applied on the compound motion assembly 10 and/or the shaft rod assembly 201 is reduced through the rotational motion of the rotating members 412, thereby reducing the wear of the compound motion assembly 10 and/or the shaft rod assembly 201. The service life of the electric valve 1 can be improved when the shaft assembly 100 is applied to the electric valve 1.

It should be noted that, the above implementations are only used to illustrate the present disclosure, and are not intended to limit the technical solutions described in the present disclosure, such as the orientations defined by terms “front”, “back”, “left”, “right”, “up”, “down” and the like. Although the present disclosure is described in this specification with reference to the above implementations, it may be appreciated by those skilled in the art that, modifications, combinations or equivalent substitutions may be made to the present disclosure by those skilled in the art, and all the technical solutions and improvements thereof without departing from the spirit and scope of the present disclosure are deemed to fall into the scope of the present disclosure defined by the claims.

1. A shaft assembly, comprising a compound motion assembly, a shaft rod assembly and a bearing assembly, wherein
the compound motion assembly is rotatable around an axis thereof and is movable, and the shaft rod assembly is movable when being pushed by the compound motion assembly;
the shaft rod assembly comprises a shaft rod and a bushing that are connected to each other, and the shaft rod comprises a bottom wall portion;
a part of the compound motion assembly is located between the bushing and the bottom wall portion in an axial direction of the shaft assembly;
the bearing assembly is provided between and can abut against the bushing and the compound motion assembly in the axial direction of the shaft assembly, and/or, the bearing assembly is provided between and can abut against the bottom wall portion and the compound motion assembly in the axial direction of the shaft assembly; and
the bearing assembly comprises a plurality of rotating members that are arranged in a circumferential direction of the compound motion assembly, and the plurality of rotating members are rotatable under an action of the compound motion assembly.

2. The shaft assembly according to claim 1, wherein
the bearing assembly further comprises a first bearing ring and a second bearing ring;
the plurality of rotating members are located between the first bearing ring and the second bearing ring in an axial direction of the bearing assembly, and the compound motion assembly passes through the first bearing ring and the second bearing ring; and
one of the first bearing ring and the second bearing ring is in interference fit with the compound motion assembly, and a gap is provided between the other of the first bearing ring and the second bearing ring and the compound motion assembly.

3. The shaft assembly according to claim 2, wherein the bearing assembly comprises a first bearing assembly and a second bearing assembly, the first bearing assembly is located between the bushing and the compound motion assembly in the axial direction of the shaft assembly, and the second bearing assembly is located between the compound motion assembly and the bottom wall portion in the axial direction of the shaft assembly.

4. The shaft assembly according to claim 3, wherein
the compound motion assembly comprises a first rod assembly, an elastic member and a second rod, and the first rod assembly and the second rod are formed separately and are arranged in the axial direction of the compound motion assembly;
a part of the elastic member is provided on the first rod assembly, and another part of the elastic member is provided on the second rod;
the first bearing assembly is provided on the first rod assembly, and the second bearing assembly is provided on the second rod; and
the elastic member is located between the first bearing assembly and the second bearing assembly in the axial direction of the shaft assembly.

5. The shaft assembly according to claim 4, wherein
the first rod assembly comprises a flange and a first rod that are connected to each other; and
in the axial direction of the shaft assembly, the first bearing assembly is located between the flange and the bushing, and the elastic member is located between the flange and the second bearing assembly.

6. The shaft assembly according to claim 5, wherein,
a second bearing ring of the first bearing assembly is located between a first bearing ring of the first bearing assembly and the bushing, and the first bearing ring of the first bearing assembly is in interference fit with the first rod and can abut against the flange; and
a gap is provided between the second bearing ring of the first bearing assembly and the first rod in a radial direction of the first rod, and the second bearing ring of the first bearing assembly abuts against the bushing.

7. The shaft assembly according to claim 4, wherein
the second rod comprises a first shaft portion and a second shaft portion;
in an axial direction of the second rod, at least a part of an orthographic projection of the first shaft portion is within an orthographic projection of the second shaft portion; and
the second bearing assembly is provided on the first shaft portion, and the second bearing assembly is located between the second shaft portion and the bottom wall portion in the axial direction of the second rod.

8. The shaft assembly according to claim 7, wherein,
the second bearing ring of the second bearing assembly is located between a first bearing ring of the second bearing assembly and the bottom wall portion, and the first bearing ring of the second bearing assembly is in interference fit with the first shaft portion and can abut against the second shaft portion; and
a gap is provided between the second bearing ring of the second bearing assembly and the first shaft portion in a radial direction of the second rod, and the second bearing ring of the second bearing assembly can abut against the bottom wall portion.

9. The shaft assembly according to claim 5, wherein
the first rod comprises a third shaft portion, a fourth shaft portion, a fifth shaft portion and a sixth shaft portion that are sequentially arranged in an axial direction of the first rod; and
in the axial direction of the first rod, at least a part of an orthographic projection of the third shaft portion is within an orthographic projection of the fourth shaft portion, at least a part of the orthographic projection of the fourth shaft portion is within an orthographic projection of the fifth shaft portion, and at least a part of the orthographic projection of the fifth shaft portion is within an orthographic projection of the sixth shaft portion.

10. The shaft assembly according to claim 9, wherein
the flange comprised in the first rod assembly is provided on an outer side surface of the third shaft portion;
a first bearing ring of the first bearing assembly is provided on an outer circumferential side of the fourth shaft portion and is in interference fit with the fourth shaft portion;
a second bearing ring of the first bearing assembly is provided on an outer circumferential side of the fifth shaft portion, and a plurality of rotating members of the first bearing assembly are circumferentially arranged around the outer circumferential side of the fifth shaft portion; and
a gap is provided between the second bearing ring of the first bearing assembly and the fifth shaft portion in the radial direction of the first rod, and the bushing is provided on an outer circumferential side of the sixth shaft portion.

11. The shaft assembly according to claim 3, wherein the first bearing assembly is a thrust ball bearing or a needle roller thrust bearing; and/or
the second bearing assembly is a thrust ball bearing or a needle roller thrust bearing.

12. The shaft assembly according to claim 1, wherein the shaft rod is provided with a through hole, and a hole wall of the through hole is located on a side of the bottom wall portion away from the bushing in an axial direction of the shaft rod.

13. An electric valve having a valve port and a valve chamber, and comprising a housing, a cover assembly and the shaft assembly according to claim 1, wherein
the cover assembly and the housing are sealedly connected, and the shaft rod of the shaft assembly is movable towards or away from the valve port; and
the housing and the cover assembly form at least a part of a wall portion of the valve chamber, and a part of the shaft rod extends through the cover assembly and is located into the valve chamber.

14. The electric valve according to claim 13, further comprising a diaphragm seal, wherein
the diaphragm seal comprises a first part, a second part and a third part, and the first part is connected to the third part through the second part;
the first part is provided on an outer surface side of a part of the shaft rod, and is sealedly connected to the shaft rod, and the third part is sandwiched between the housing and the cover assembly;
the cover assembly has a first surface and a second surface, the second surface is located on an inner side of the first surface in a radial direction of the cover assembly, and the first surface abuts against the third part; and
the second surface is located closer to the second part than the first surface in an axial direction of the cover assembly.

15. The electric valve according to claim 14, wherein
the cover assembly is provided with a second accommodation chamber, a mounting opening and a limiting opening, and the mounting opening and the limiting opening are respectively located on both axial sides of the cover assembly and are in communication with each other through the second accommodation chamber;
a part of the shaft rod is located inside a portion where the limiting opening is located;
the shaft assembly comprises a shaft rod, and the shaft rod is provided with a through hole, and the electric valve further comprises an anti-rotation pin, the anti-rotation pin extends through the through hole and is limitedly arranged relative to the cover assembly; and
at least a part of the mounting opening has an inner diameter larger than or equal to a axial length of the anti-rotation pin, and an inner diameter of the limiting opening is smaller than the axial length of the anti-rotation pin.
